(19) United States
(12) Patent Application Publication
(10) Pub. No.: US 2004/0098361 A1
(43) Pub. Date: May 20, 2004

(54) Managing electronic file updates on client devices

(76) Inventor: Luosheng Peng, Alviso, CA (US)

Correspondence Address: Shemwell Gregory & Courtney LLP, Suite 201, 4880 Stevens Creek Boulevard, San Jose, CA, 95129, US

(21) Appl. No.: 10/298,896

(22) Filed: Nov. 18, 2002

(51) Int. Cl. G06F 7/00

(52) U.S. Cl. 707/1

(57) ABSTRACT

An upgrade controller controls file upgrades on a client device in response to the receipt of a new electronic file that is an upgraded version of an original file hosted on the client device. The upgrade controller estimates the resources that will be used by the client device in upgrading the original electronic file using the new electronic file. Furthermore, the upgrade controller reads upgrade process control parameters from a user profile. The upgrade process control parameters include user preference information relating to the upgrade process, and are selected or defined by the user of the client device. The upgrade controller uses information of the estimated resources and the upgrade process control parameters to control the upgrade of the original file on the client device without interrupting normal operation of the client device and without violating the user preferences.

### RELATED APPLICATIONS

This application is related to the application titled BYTE-LEVEL FILE DIFFERENCING AND UPDATING ALGORITHMS, application Ser. No. 10/146,545, filed May 13, 2002, the application titled UPDATING ELECTRONIC FILES USING BYTE-LEVEL FILE DIFFERENCING AND UPDATING ALGORITHMS, application Ser. No. 10/261,153, filed Sep. 30, 2002, the application titled UPGRADING OF ELECTRONIC FILES INCLUDING AUTOMATIC RECOVERY FROM FAILURES AND ERRORS OCCURRING DURING THE UPGRADE, Attorney Docket Number DOGO.P005 (Application Number not yet assigned), filed Nov. 12, 2002, the application titled DEVICE MEMORY MANAGEMENT DURING ELECTRONIC FILE UPDATING, Attorney Docket Number DOGO.P003 (Application Number not yet assigned), filed Nov. 18, 2002, the application titled GENERATING DIFFERENCE FILES USING MODULE INFORMATION OF EMBEDDED SOFTWARE COMPONENTS, Attorney Docket Number DOGO.P004 (Application Number not yet assigned), filed Nov. 18, 2002, the application titled CONTROLLING UPDATES OF ELECTRONIC FILES, Attorney Docket Number DOGO.P006 (Application Number not yet assigned), filed Nov. 18, 2002, and the application titled SCHEDULING UPDATES OF ELECTRONIC FILES, Attorney Docket Number DOGO.P007 (Application Number not yet assigned), filed Nov. 18, 2002, all of which are currently pending.

### TECHNICAL FIELD

The disclosed embodiments relate to updating and maintaining electronic files.

### BACKGROUND

Software running on a processor or central processing unit (CPU) to provide functionality in the host device often changes over time. The changes may result from the need to correct bugs, or errors, in the software files, adapt to evolving technologies, or add new features. In particular, embedded software components hosted on mobile wireless devices often include numerous software bugs that require correction.

Software includes one or more files in the form of human-readable American Standard Code for Information Interchange (ASCII) plain text files or binary code. Software files can be divided into smaller units that are often referred to as modules or components. A UNIX platform or personal computer (PC) includes multiple software components, and each of the software components is managed and updated independently through a file system supported by a corresponding operating system (OS). Information used to update software files or software components hosted on UNIX platforms or PCs can be transferred through the Internet or loaded from a secondary storage medium such as a floppy disk, a compact disk read-only memory (CD-ROM), or a compact flash card.

In contrast, in mobile wireless devices, a real-time operating system (RTOS) is typically used in which all software components are linked as a single large file. Further, no file system support is typically provided in these mobile wireless devices. In addition, the single large file needs to be preloaded, or embedded, into the device using a slow communication link like a radio, infrared, or serial link.

Obstacles to updating the large files of mobile wireless devices via slow communication links include the time, bandwidth, and cost associated with delivering the updated file to the device. Distribution of such large files can take an undesirably long time from the point of view of the customer and can consume a large amount of server resources from the point of view of the file provider. Delivering a large file over an unreliable communication link such as a radio link may also increase the rate of communication failure and require a large working memory within the device, for example random access memory (RAM).

One solution to the problem of delivering large files to mobile devices for use in updating files of the mobile devices uses difference programs to generate difference files. The difference files include data that describes how a revised file differs from an original file. While use of the various difference programs helps reduce the size of the transferred files, network traffic management issues remain because the service provider or software provider has many subscribers or customers to which they must potentially provide updated files including difference files.

Generally, the number of subscribers supported by a service provider along with bandwidth limitations of the associated network prohibits timely updates of all files on all subscriber devices each time a new update becomes available. However, the service provider does have to ensure that particular updates (e.g., bug fixes) to particular files are distributed in a timely fashion. Therefore, even when using difference files to reduce the network bandwidth requirements per file transfer, the service provider is faced with managing the delivery of software upgrades to large numbers of supported users.

### BRIEF DESCRIPTION OF THE FIGURES

FIG. 1 is a block diagram of a file upgrade system including an upgrade controller for controlling file upgrades on a host device, under an embodiment.

FIG. 2 is a block diagram of an example service provider infrastructure including components of the file upgrade system of an embodiment.

FIG. 3 is a flow diagram for controlling file upgrades on a client device using the upgrade controller, under the embodiment of FIG. 1.

FIG. 4 is a block diagram of an upgrade controller for use in controlling file upgrades in a client device, under the embodiment of FIGS. 1 and 3.

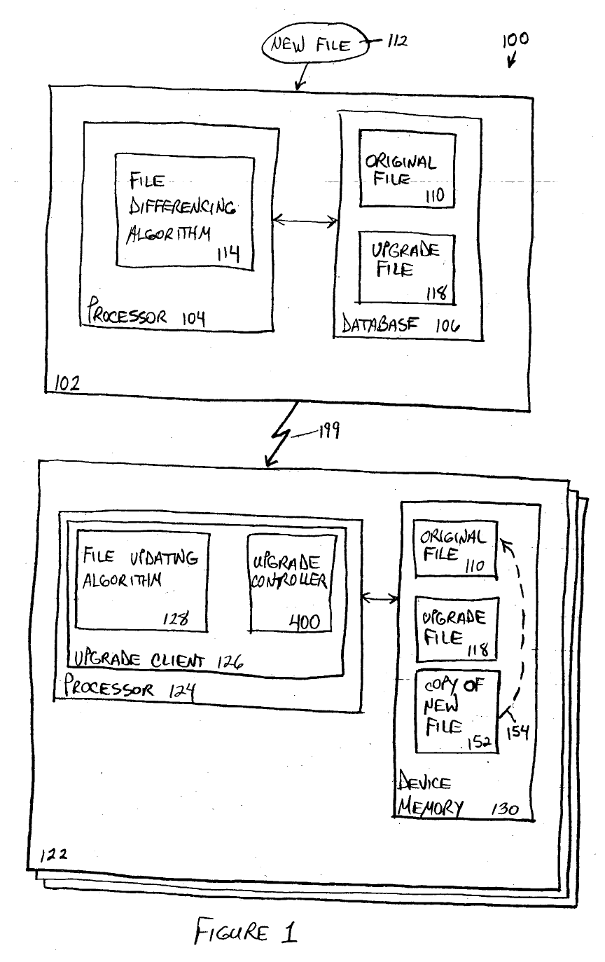

In the drawings, the same reference numbers identify identical or substantially similar elements or acts. To easily identify the discussion of any particular element or act, the most significant digit or digits in a reference number refer to the Figure number in which that element is first introduced (e.g., element 126 is first introduced and discussed with respect to FIG. 1).

Unless described otherwise below, the construction and operation of the various blocks and structures shown in the Figures are of conventional design. As a result, such blocks need not be described in further detail herein, because they will be understood by those skilled in the relevant art. Such further detail is omitted for brevity and so as not to obscure the detailed description of the invention. Any modifications necessary to the Figures can be readily made by one skilled in the relevant art based on the detailed description provided herein.

### DETAILED DESCRIPTION

An upgrade system and associated methods are provided below for controlling intelligent, trouble-free management of automatic software upgrades on host devices like, for example, mobile devices. The upgrade system includes an upgrade controller that resides on a host or client device. The upgrade controller includes a resource planner, a user configuration profile, and a resource monitor for use in managing the file upgrades on the client device. The resource planner estimates resource requirements of the client device for associated upgrade requests. The user configuration profile allows the user to define “rules” for scheduling and controlling the file upgrades and the user interaction during the upgrade process. The resource monitor controls upgrades on the host device using information of the resource planner and user configuration profile.

In the following description, numerous specific details are introduced to provide a thorough understanding of, and enabling description for, embodiments of the invention. One skilled in the relevant art, however, will recognize that the invention can be practiced without one or more of the specific details, or with other components, systems, etc. In other instances, well-known structures or operations are not shown, or are not described in detail, to avoid obscuring aspects of the invention.

In controlling file upgrades on the client device, components of the upgrade controller receive a new electronic file, or new file, that is an upgraded version of an original file hosted on the client device. The upgrade controller estimates the resources that will be used by the client device in upgrading the original electronic file using the new electronic file. Furthermore, the upgrade controller reads upgrade process control parameters from a user profile. The upgrade process control parameters include user preference information relating to the upgrade process, and are selected or defined by the user of the client device. The upgrade controller uses information of the estimated resources and the upgrade process control parameters to reliably control the upgrade of the original file on the client device without interrupting normal operation of the client device and without violating the user preferences.

FIG. 1 is a block diagram of a file upgrade system 100 including an upgrade controller 400 for controlling file upgrades on a host device 122, under an embodiment. Generally, the file upgrade system 100 includes a first computer system 102 and one or more second computer systems 122 communicating via a communication path 199. These computer systems 102 and 122 include any collection of computing devices operating together, as is known in the art. The computer systems 102 and 122 also include components within a larger computer system. The communication path 199 includes any medium for communicating or transferring files among the computer systems 102 and 122. Therefore, this path 199 includes wireless connections, wired connections, and hybrid wireless/wired connections. The communication path 199 also includes couplings or connections to networks including local area networks (LANs), metropolitan area networks (MANs), wide area networks (WANs), proprietary networks, interoffice or backend networks, and the Internet. Furthermore, the communication path 199 includes removable fixed mediums like floppy disks, hard disk drives, and CD-ROM disks, as well as flash RAM, Universal Serial Bus (USB) connections, RS-232 connections, telephone lines, buses, and electronic mail messages.

The first 102 and second 122 computer systems each include an original version 110 of an electronic file, referred to herein as the original file 110. The first computer system 102 stores the original file 110 in a database 106 or other memory area or combination of memory areas or devices, but is not so limited. The second computer system 122 stores the original file 110 in device memory for use in operation.

At such time as a software provider upgrades the original file 110, for example to provide additional functionality or to fix a software bug, a new version 112 of the electronic file is generated. The new version 112 of the electronic file is referred to herein as the new file 112. The new file 112 is generally an updated or revised version of the original file 110, but is not so limited. The software provider transfers the new file 112 to the first computer system 102.

The electronic files 110 and 112 include software files including dynamic link library files, shared object files, embedded software components (EBSCs), firmware files, executable files, data files including hex data files, system configuration files, and files including personal use data, but are not so limited. Since any type of file can be regarded as a byte stream, hereafter a file can be described as a byte stream.

Components of the first computer system 102 including at least one processor 104 receive and process the new file 112 in order to generate upgrade information for use in upgrading the hosted original files 110 of the second computer system 122. In an embodiment, the processor 104 generates an upgrade file 118 for use in transferring information of the upgrades to the second computer systems 122.

The upgrade file 118 can include a difference file that codes differences between the new file 112 and the original file 110 or, alternatively, can include any number and/or combination of components or modules of the new file 112. In embodiments where the upgrade file 118 includes a difference file, components of the first computer system 102 including the processor 104 and the file differencing algorithm 114 process a comparison between the new file 112 and the corresponding original file 110, thereby calculating the differences between the new file 112 and the original file 110. The file differencing algorithm 114 generates the difference file during the comparison and writes the difference file to the upgrade file 118.

Components of the first computer system 102 provide the upgrade information to the second computer systems 122, in accordance with the notification schedules, via transfer of the upgrade file 118 over the communication path 199. Prior to transfer, the upgrade file 118 may be compressed using any of a number of compression techniques known in the art, but is not so limited.

Components of the second computer system 122 including the upgrade controller 400, the file updating algorithm 128, and the processor 124 receive the upgrade file 118 and control the upgrade of the original file using the upgrade file 118. In an embodiment, the upgrade client 126, including the upgrade controller 400 and the file updating algorithm 128, processes information of the upgrade file 118 along with the hosted original file 110 to generate a copy of the new file 152. This copy of the new file 152 is subsequently used by the upgrade client 126 to upgrade 154 the targeted original file 110 hosted on the client device 122. The upgrade client 126 of an embodiment uses numerous methods to update EBSCs depending on the file type to be updated and the resources allocated by the client device manufacturer to support these updates, as described in the Related Applications. Upon completion of this update process, the original file 110 now stored on the second computer system 122 is the same as the new file 112 received in the first computer system 102.

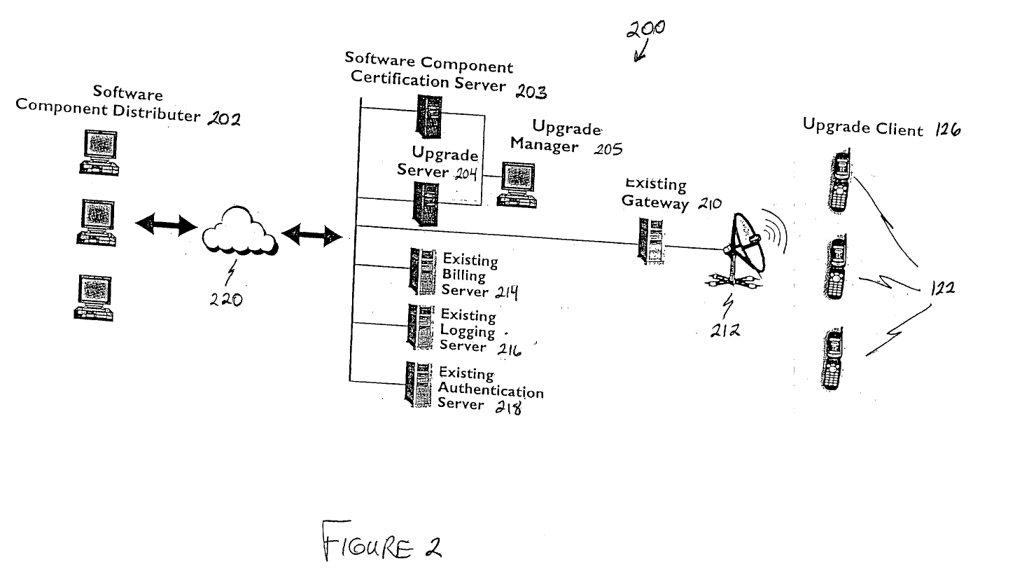

FIG. 2 is a block diagram of an example service provider infrastructure 200 including components of the file upgrade system 100 of an embodiment. In this embodiment the service provider infrastructure is described in the context of a cellular telephone network or infrastructure, but alternative embodiments are not so limited. The service provider infrastructure 200 includes, but is not limited to, a Software Component Distributor (SCD) 202, service provider upgrade components 203-205, and an upgrade client 126 hosted on the client devices 122. The service provider upgrade components 203-205 include an upgrade server 204 coupled among a software component certification server 203 and an upgrade manager 205.

With further reference to FIG. 1, the SCD 202 of an embodiment of the service provider infrastructure 200 includes components or functions of the first computer system 102. In alternative embodiments, the service provider upgrade components 203-205 host components or functions of the first computer system 102. In other alternative embodiments the components or functions of the first computer system 102 are distributed among components of the SCD 202 and the service provider upgrade components 203-205.

The service provider infrastructure 200 of an embodiment supports numerous types of software file or component upgrades on client devices 122 including mobile electronic devices, mobile communication devices, cellular telephones, personal digital assistants, computers, and other processor-based devices via the upgrade system components and various mechanisms of the service provider's wireless infrastructure. These systems function by receiving new and revised software from a software distributor, generating an upgrade file from the new software, and transferring the upgrade file to the client device 122 via the service provider infrastructure. The upgrade client 126 of the receiving or client device 122 uses the upgrade file to update the targeted software hosted on the client device 122.

The SCD 202 of an embodiment provides a user interface by which software providers package and release new embedded device software components. Functions of the SCD 202 include registering device information and submitting device information to the software component certification server. Also, the SCD 202 receives new and original EBSCs, calculates or generates file differences using the new and original EBSCs, registers and packages embedded software, and submits embedded software packages to the software component certification server 203. The new or revised software, following release, is provided to the service provider upgrade components 203-205 via a wired, wireless, or hybrid wired/wireless network coupling or connection 220, but is not so limited.

The SCD 202 of an embodiment is hosted on processing systems of the client device manufacturers. In an alternative embodiment, the SCD 202 is hosted on processing systems of an application or system software provider. In another alternative embodiment, the SCD 202 is hosted on processing systems of the service carrier or provider, for example hosted on or distributed among the upgrade components 203-205.

The service provider upgrade components 203-205 are coupled among the software component distributor 202, the client devices 122, and the existing components of the service provider's infrastructure 210-218, including the existing gateway 210 and communication infrastructure 212, billing server 214, logging server 216, and authentication server 218.

The software component certification server 203 provides an interface to the manufacturers of client devices and, thus, receives new device information on embedded software packages from device manufacturers. The software component certification server 203 also repackages and distributes approved software packages to upgrade servers.

The upgrade manager 205, while functioning as an interface among the software component certification server 203 and the upgrade server 204, configures software and data packaging for optimal device management, schedules remote change notifications, and controls the update policy monitor system. Moreover, the upgrade manager 205 provides integration with the systems of the existing infrastructure.

The upgrade server 204 provides capabilities including authenticating, connecting, and communicating with mobile client devices 122 to perform embedded software component upgrades. Communication with client devices 122 can occur via couplings 212 with the client devices 122 that include wireless couplings, wired couplings, hybrid wired/wireless couplings, and other network coupling types, as appropriate to the corresponding service provider. In addition, the upgrade server 204 supports existing billing, data collection, and logging services of the service provider.

As an example of communications among the upgrade server 204 and client devices 122, when an upgrade file is available for transfer to a client device 122 from the upgrade server 204, the server 204 sends a user notification to notify the client device user that there are software components available for updating. The user notification is transmitted in accordance with the schedules generated by components of the traffic manager 120. The user notification can take the form of a text message via a Short Message Service (SMS) push protocol, Hypertext Transfer Protocol (HTTP), or Wireless Application Protocol (WAP), but is not so limited. Upon receiving confirmation from the handset users, the upgrade server 204 uses the original handset data communication protocol to send the upgrade file to the requesting handset.

In response to receipt of the confirmation from the handset, the upgrade server 204 authenticates and authorizes the user and/or requesting device, and verifies prerequisite capabilities and limitations of the requesting device. Following authentication the upgrade server 204, as the manager of client device configuration data, identifies the current versions of embedded software components of the requesting device 122, identifies and transfers appropriate upgrade files to the requesting device 122, logs the status of the upgrade transaction, and reports the results to the upgrade manager 205.

The service providers of an embodiment, in providing software updates to client devices, use control policies to effectively manage the network capacity and control issues associated with the distribution of upgrade files to large numbers of users. These update control policies control the launch and execution of associated file upgrades, and are determined and assigned by the service provider. While many update control policies and combinations of policies are possible, two particular policies include an automatic update control policy and a user-selected update control policy. The automatic update supports the automatic updating of files on the client device without any action from the device user, while the user-selected update launches an update in response to some action by the device user. Any number/combination of or other update control policies may be used as recognized by one skilled in the art.

While the update control policies help a service provider control delivery of upgrades, components of the upgrade client 126 hosted on the client device provide the capability to efficiently manage the upgrade process on the client device platform. Among the components of the upgrade client 126 that control the upgrade process, an upgrade controller uses information of the estimated resources and the upgrade process control parameters to reliably control the upgrade of the original file on the client device. The upgrade controller controls the launch of upgrades on the client device without interrupting normal operation of the client device and without violating the user preferences, as described below.

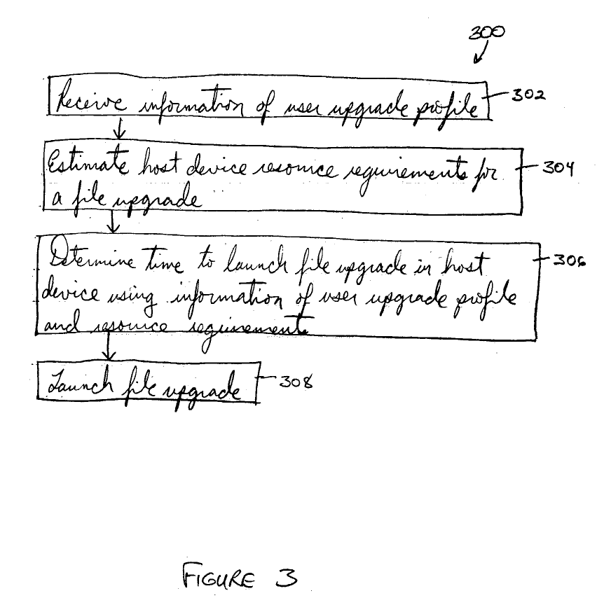

FIG. 3 is a flow diagram 300 for controlling file upgrades on a client device using the upgrade controller, under an embodiment of FIG. 1. In response to receipt of a new file that is an upgraded version of an original file hosted on the client device, components of the upgrade controller read or receive upgrade process control parameters or information, at block 302. The upgrade process control parameters include user preference information relating to the upgrade process, and are selected or defined by the user of the client device. The upgrade process control parameters of an embodiment are stored in a user upgrade profile or user profile, but are not so limited. The upgrade controller estimates the resources that will be used by the client device in upgrading the original electronic file, at block 304. The resource estimates include, for example, estimates of the amount of memory and time needed to perform the upgrade as well as an estimated amount of available memory, battery power, and processing time available to support the upgrade in the host device.

The upgrade controller uses information of the estimated resources and the upgrade process control parameters to determine launch parameters of the file upgrade, at block 306. The select launch parameters reduce or eliminate interruption of normal device operation and violations of user preferences during the upgrade process. The upgrade client 126 launches the file upgrade at the appropriate launch time, at block 308.

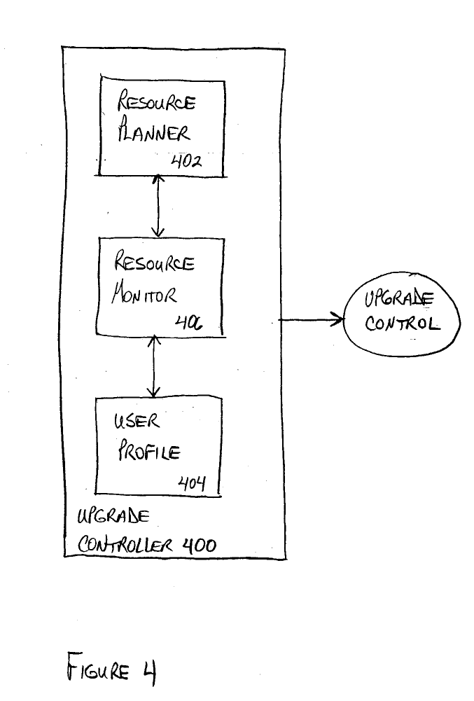

FIG. 4 is a block diagram of an upgrade controller 400 for use in controlling file upgrades in a client device, under the upgrade system embodiment of FIG. 1. Components of the upgrade controller 400 include, but are not limited to, a resource monitor 406 coupled among a resource planner 402 and a user profile 404, as described below.

The resource planner 402 couples among components of the client device including the processor 124 and device memory 130, with reference to FIG. 1. The resource planner 402, using information of the upgrade file 118, estimates the resources that will be used by the client device in upgrading the original electronic file using the new electronic file. For example, the resource planner 402 estimates the amount of memory that will be used in support of an upgrade. Additionally, the resource planner 402 estimates the time needed to perform an upgrade. The resource planner 402 can estimate additional parameters needed in the upgrade process as known to one skilled in the art.

Through the couplings to components of the client device, the resource planner 402 of an embodiment also gathers information as to the current usage status of the components. Using this usage information, the resource planner 402 can provide information as to an estimated amount of memory available in the client device. Furthermore, the resource planner 402 provides information as to remaining battery power as well as available processing time of the processor 124. The resource planner 402 can provide additional usage information for components of the client device as known to one skilled in the art.

The user profile 404 includes control parameters of the upgrades over which the user has control, referred to herein as upgrade process control parameters. The service provider, client device manufacturer, and/or client device software provider determine the upgrade process control parameters, but the embodiment is not so limited.

The upgrade process control parameters of an embodiment define user-specified conditions under which upgrades of client device files are to be launched, conditions that generally include when and how to perform an upgrade. As an example, a user can specify whether or not to let an incoming call or message to the client device interrupt an upgrade in progress. Likewise, a user can specify whether or not to let an outgoing call or message from the client device interrupt an upgrade in progress.

A user can also specify time periods during which upgrades can occur. As one example, users can specify specific time periods during which upgrades are to be performed. In another example, users can generally specify upgrades to occur during times when the device is idle. As yet another example, users can specify upgrades to occur after the client device has been idle for more than a specified period of time. Various alternative embodiments can use any number of additional timing constraints or combinations of the timing constraints above, as contemplated by one skilled in the art.

As still another example of upgrade process control parameters, a user can specify via the user profile performance of automatic upgrades in response to a user confirmation message. Timing constraints can be specified for performing the upgrade in response to a user confirmation, for example, specifying performance of the upgrade immediately upon receipt of the user confirmation message or, alternatively, upon expiration of a pre-specified time period. In the absence of a user confirmation message, the user can program the user profile to either not launch the upgrade, or to launch the upgrade upon expiration of a user-specified timeout period. While these examples are provided, the user profile 404 can include additional user-specified parameters to control the upgrade process as known to one skilled in the art.

The user profile 404 is generated using inputs from the device user. In an embodiment, the user inputs the preference information directly into the client device in response to electronic prompts or queries at the device. In an alternative embodiment, the user may log onto a World Wide Web (“web”) site provided by the service provider or software provider in order to generate a user profile which is then associated with the user's account. In yet another alternative embodiment, the user specifies the user profile 404 to the service provider at such time as the user activates service to the client device.

The resource monitor 406 couples among the resource planner 402 and the user profile 404. The resource monitor 406 receives information of the estimated resources and the upgrade process control parameters from the resource planner 402 and the user profile 404, respectively. The resource monitor 406 launches an upgrade of an original file using received information of an associated upgrade file upon determining that the upgrade will meet all parameters specified in the information received from the resource planner 402 and the user profile 404. In this manner, the resource monitor 406 uses the received information to reliably control the timing and performance of upgrades of the original file on the client device without interrupting normal operation of the client device and without violating the user preferences.

Aspects of the invention may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the invention include: microcontrollers with memory (such as electronically erasable programmable read only memory (EEPROM)), embedded microprocessors, firmware, software, etc. Furthermore, aspects of the invention may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” and words of similar import, when used in this application, shall refer to this application as a whole and not to any particular portions of this application.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings of the invention provided herein can be applied to other processing systems and communication systems, not only for the file updating described above.

The elements and acts of the various embodiments described above can be combined to provide further embodiments. These and other changes can be made to the invention in light of the above detailed description.

All of the above references and United States patents and patent applications are incorporated herein by reference. Aspects of the invention can be modified, if necessary, to employ the systems, functions and concepts of the various patents and applications described above to provide yet further embodiments of the invention.

In general, in the following claims, the terms used should not be construed to limit the invention to the specific embodiments disclosed in the specification and the claims, but should be construed to include all processing systems that operate under the claims to provide a method for file differencing and updating. Accordingly, the invention is not limited by the disclosure, but instead the scope of the invention is to be determined entirely by the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

What I claim is:

1. A system for providing automatic update management of electronic files, comprising:
a first device that generates a new electronic file that is an upgraded version of a corresponding original electronic file; and
a second device that receives the new electronic file from the first device via at least one coupling, wherein the second device includes at least one processor configured to control upgrading of original electronic files hosted on the second device by,
estimating resources to be used by the host device in an upgrade of the original electronic file using the new electronic file;
reading upgrade process control parameters from a user profile; and
controlling the upgrade using information of the resource estimates and the upgrade process control parameters.

2. The system of claim 1, wherein controlling the upgrade further comprises launching the upgrade when the information of the resource estimates and the upgrade process control parameters indicate that resources of the second device are available to perform the upgrade and the upgrade can be performed within user-specified time constraints and usage constraints of the second device.

3. The system of claim 1, wherein the second device is at least one processor-based device selected from among personal computers, portable computing devices, cellular telephones, portable communication devices, and personal digital assistants.

4. The system of claim 1, wherein the at least one coupling is selected from among wireless couplings, wired couplings, hybrid wireless/wired couplings, and couplings to networks including local area networks (LANs), metropolitan area networks (MANs), wide area networks (WANs), proprietary networks, backend networks, the Internet, and removable fixed mediums including floppy disks, hard disk drives, and CD-ROM disks, as well as telephone lines, buses, and electronic mail messages.

5. The system of claim 1, wherein the original and new electronic files comprise software files including dynamic link library files, shared object files, embedded software components (EBSCs), firmware files, executable files, data files including hex data files, system configuration files, and files including personal use data.

6. The system of claim 1, wherein the new electronic file is at least one of a new version of the original electronic file and a difference file, wherein the difference file includes coded differences between the new electronic file and the original electronic file.

7. A method for automatically controlling electronic file upgrades of a host device, comprising:
receiving a new electronic file that is an upgraded version of an original electronic file;
estimating resources to be used by the host device in an upgrade of the original electronic file using the new electronic file;
reading upgrade process control parameters from a user profile; and
controlling the upgrade using information of the resource estimates and the upgrade process control parameters.

8. The method of claim 7, wherein controlling the upgrade further comprises launching the upgrade when the information of the resource estimates and the upgrade process control parameters indicate that host device resources are available to perform the upgrade and the upgrade can be performed within user-specified time and host device usage constraints.

9. The method of claim 7, wherein estimating resources includes:
determining at least one of an amount of memory and time needed to perform the upgrade; and
determining at least one of an estimated amount of available memory, battery power, and processing time available in the host device.

10. The method of claim 7, further comprising generating a user profile in response to upgrade process control parameters received from a user of the host device.

11. The method of claim 10, wherein the user inputs the upgrade process control parameters into the host device.

12. The method of claim 7, wherein the upgrade includes at least one of an automatic upgrade policy and a user-selected upgrade policy.

13. The method of claim 7, wherein the new electronic file is at least one of a new version of the original electronic file and a difference file, wherein the difference file includes coded differences between the new electronic file and the original electronic file.

14. The method of claim 7, wherein the host device is a cellular telephone.

15. An apparatus that controls electronic file upgrades in a portable host device, comprising:
means for receiving a new electronic file that is an upgraded version of an original electronic file;
means for estimating resources to be used by the host device in an upgrade of the original electronic file using the new electronic file;
means for reading upgrade process control parameters from a user profile; and
means for controlling the upgrade using information of the resource estimates and the upgrade process control parameters.

16. The apparatus of claim 15, wherein the means for controlling the upgrade further comprises means for launching the upgrade when the information of the resource estimates and the upgrade process control parameters indicate that host device resources are available to perform the upgrade and the upgrade can be performed within user-specified time and host device usage constraints.

17. The apparatus of claim 15, wherein the means for estimating resources includes:
means for determining at least one of an amount of memory and time needed to perform the upgrade; and
means for determining at least one of an estimated amount of available memory, battery power, and processing time available in the host device.

18. The apparatus of claim 15, further comprising means for generating a user profile in response to upgrade process control parameters received from a user of the host device.

19. The apparatus of claim 15, wherein the portable host device is a cellular telephone.

20. A computer readable medium including executable instructions which, when executed in a processing system, control electronic file upgrades in a host device by:
receiving a new electronic file that is an upgraded version of an original electronic file;
estimating resources to be used by the host device in an upgrade of the original electronic file using the new electronic file;
reading upgrade process control parameters from a user profile; and
controlling the upgrade using information of the resource estimates and the upgrade process control parameters.
